(19) United States
(12) Patent Application Publication
(10) Pub. No.: US 2013/0342686 A1
(43) Pub. Date: Dec. 26, 2013

(54) METHOD FOR CALIBRATING A MEASURING STATION FOR MEASURING A VEHICLE

(71) Applicants: Christian Wagmann, Muenchin (DE); Volker Uffenkamp, Ludwigsburg (DE)

(72) Inventors: Christian Wagmann, Muenchin (DE); Volker Uffenkamp, Ludwigsburg (DE)

(21) Appl. No.: 13/821,046

(22) PCT Filed: Jul. 21, 2011
(86) PCT No.: PCT/EP11/62498

§ 371 Date: Sep. 13, 2013

(30) Foreign Application Priority Data
Sep. 13, 2010 (DE) 10 2010 040 626.0

(51) Int. Cl. G01B 11/14

(52) U.S. Cl. CPC G01B 11/14
USPC 348/139

(57) ABSTRACT

A method for calibrating a measuring system for measuring a vehicle, including a measuring plane for accommodating a vehicle to be measured and two measuring sensors, each of the measuring sensors having at least two camera systems, includes: positioning at least four measuring panels on the measuring plane; orienting the measuring sensors such that at least one measuring panel is in view of each camera system, and each measuring panel is in view of at least one camera system; carrying out a first measuring step of recording images of the measuring panels; interchanging the two measuring sensors; carrying out a second measuring step of recording images of the measuring panels; determining and comparing positions of the measuring panels recorded in the first and second measuring steps; and calculating at least one correction value from the difference between the positions recorded in the first and second measuring steps.

### CROSS REFERENCE TO RELATED APPLICATIONS

The present application is the national stage entry of International Patent Application No. PCT/EP2011/062498, filed on Jul. 21, 2011, which claims priority to Application No. DE 10 2010 040 626.0, filed in the Federal Republic of Germany on Sep. 13, 2010.

### FIELD OF INVENTION

The present invention relates to a method for calibrating a measuring station for measuring a vehicle, in particular a method for calibrating a measuring station which is equipped with two measuring sensors.

### BACKGROUND INFORMATION

To measure a vehicle or chassis, images of the vehicle to be measured, or images of measuring points (targets) attached to the vehicle to be measured, are recorded with the aid of measuring sensors, each of which has at least two cameras. As a rule, one measuring sensor each is positioned to the left and right of the vehicle to be measured. To avoid errors during vehicle measurement and, in particular when determining the track, the system must be calibrated in such a way that the coordinate systems defined by the measuring sensors on the left side and on the right side of the vehicle are identical.

### SUMMARY

An object of the present invention is to provide a reliable and cost-effective method for calibrating a measuring station for measuring a vehicle which includes two measuring sensors.

A method according to the present invention for calibrating a measuring system for measuring a vehicle, which includes a measuring plane designed to accommodate a vehicle to be measured and two measuring sensors, each of the measuring sensors having at least two camera systems and one calibrated reference system, includes the following steps:

positioning at least four measuring panels on the measuring plane;

orienting the measuring sensors in such a way that at least one of the measuring panels is in the field of vision of each camera system, and each of the measuring panels is in the field of vision of at least one of the camera systems;

carrying out a first measuring step which includes recording images of the measuring panels with the aid of the camera systems;

interchanging the two measuring sensors (reversible measurement);

carrying out a second measuring step which includes recording images of the measuring panels with the aid of the camera systems;

determining the positions of the measuring panels from the images recorded in the first and second measuring steps; and

calculating at least one correction value from the difference between the positions of the measuring panels which have been determined from the images recorded in the first and second measuring steps.

The correction value determined in this way is stored and taken into account during evaluation in the following vehicle measurement for the purpose of correcting the measuring results. By taking into account a correction value of this type, the parameters of the vehicle geometry and, in particular, the track values of the vehicle to be measured may be determined with a high degree of accuracy, since errors resulting from an incompletely parallel orientation of the camera systems are taken into account and corrected.

Due to the calibration according to the present invention, the two measuring sensors used form a common measuring system and are operable only in combination with each other. If one of the measuring sensors is replaced with another, the newly formed measuring system must be recalibrated. By storing the serial numbers of the measuring sensors during calibration, and by comparing the stored serial numbers with the instantaneous serial numbers during each measurement, it is possible to check whether the instantaneously stored correction value is still valid. Faulty measurements which are carried out with the aid of an uncalibrated measuring system may thus be reliably prevented.

In one exemplary embodiment, the correction value is determined by solving a linear system of equations. By solving a linear system of equations, the searched for correction value may be easily determined with a good degree of accuracy.

In one exemplary embodiment, the correction value is defined for one of the measuring sensors (e.g., set to zero) for the purpose of determining the correction value of the other measuring sensor.

The linear system of equations to be solved includes two equations having two unknowns; no unique solution therefore exists. However, for measuring the axles, for example, it is sufficient for the track directions on the left and right sides of the vehicle to match each other relatively, i.e., for the left and right track directions to be parallel to each other. By defining the correction value for one of the measuring sensors, the correction value of the other measuring sensor may be determined by solving the linear system of equations.

In another exemplary embodiment, the normal vectors of two measuring panels are compared with each other. By comparing the normal vectors of two measuring panels, the accuracy of the correction value and thus also the accuracy of the following vehicle measurement may be increased.

In one exemplary embodiment, the correction values for two pairs of measuring panels are determined, and a final correction value is determined by averaging the two correction values. This makes it possible to even further increase the accuracy of the determined correction value.

In one exemplary embodiment, the measurement is carried out on a leveled (lifting) platform, the platform and the measuring panels being oriented in relation to the gravitational field. On a leveled platform, the method may be carried out using simple measuring panels.

In one exemplary embodiment, at least one of the measuring panels has at least two measuring points whose orientation in relation to the orientation of a foot of the measuring panel is known. A measuring panel of this type may be easily and accurately oriented.

In one exemplary embodiment, at least one of the measuring panels is rotatably mounted. A rotatably mounted measuring panel may be oriented independently of the orientation of the measuring station, and no requirements are therefore imposed on the levelness and/or orientation of the measuring station. The measurements may thus be carried out with a high degree of accuracy at any measuring station.

In one exemplary embodiment, the measuring panel has at least one level or spirit level which is suitable for determining the spatial orientation of the measuring panel. With the aid of the level attached to the measuring panel, the measuring panel may be particularly easily and accurately oriented to the desired position.

Exemplary embodiments of the present invention will be described in greater detail below with reference to the accompanying drawings.

### BRIEF DESCRIPTION OF THE DRAWINGS

FIG. 1 shows a schematic top view of a measuring station for carrying out a method according to the present invention, including two measuring sensors.

FIG. 2 shows a schematic top view of a measuring station for carrying out a method according to the present invention, the measuring sensors being interchanged in relation to the configuration illustrated in FIG. 1.

FIG. 3 shows a transformation of the images of the measuring panels recorded in the first and second measuring sensor configuration.

FIG. 4 shows a first exemplary embodiment of a measuring panel.

FIG. 5 shows a second exemplary embodiment of a measuring panel.

### DETAILED DESCRIPTION

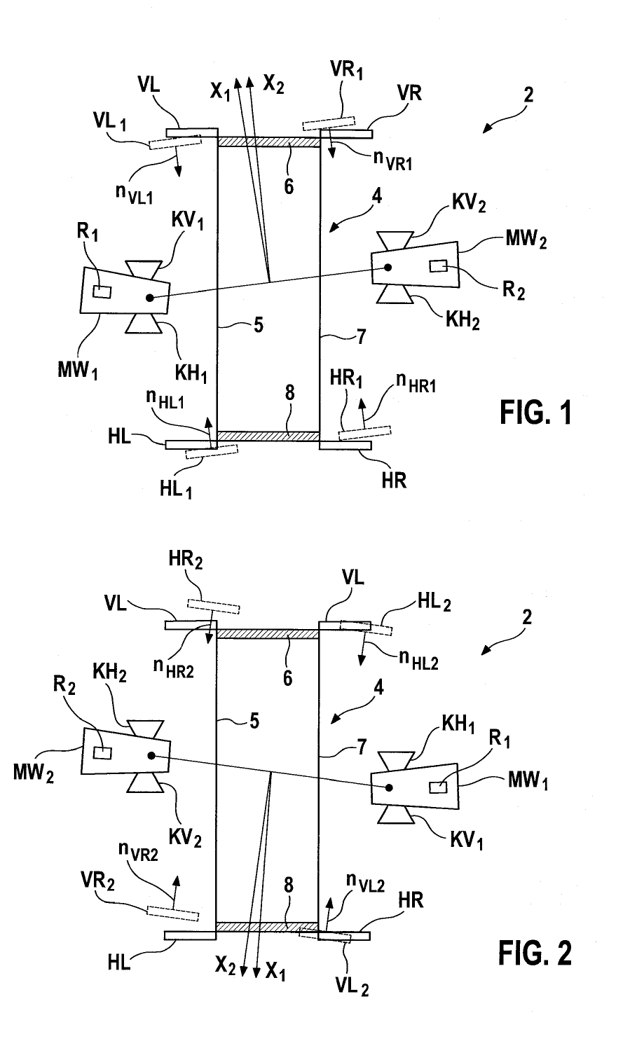

FIG. 1 shows a measuring station 2 for carrying out a method according to the present invention, including a measuring plane 4 which is provided for accommodating a vehicle to be measured.

In the exemplary embodiment of a measuring station 2 illustrated in FIG. 1, measuring plane 4 is designed in the shape of a rectangle which has a front side 6, a back side 8, a left side 5 and a right side 7. One measuring panel VL, VR, HL, HR is situated on each of the four corners of rectangular measuring plane 4. Measuring panels VL, VR, HL, HR are oriented essentially parallel to front and back sides 6, 8 at an essentially right angle to left and right sides 5, 7 of measuring plane 4.

However, measuring panels VL, VR, HL, HR are not necessarily oriented exactly parallel to front side 6 or back side 8 of measuring plane 4 and are also not absolutely in the shape of a rectangle. The positions and orientations of measuring panels VL, VR, HL, HR have generally unknown deviations from the idealized configuration illustrated in FIG. 1.

The positions of measuring panels VL, VR, HL, HR should not change during the entire calibration and measuring operation, which is described below. Measuring panels VL, VR, HL, HR may be set up on the base of measuring plane 4, fixed to a suitable frame, which is not shown in the figures, or attached to the vehicle to be measured, which is not shown in the figures.

Measuring sensors MW1, MW2 are each situated to the left and right of measuring plane 4. Each of measuring sensors MW1, MW2 has one calibrated reference system R1, R2 and two camera systems KV1, KH1, KV2, KH2. Camera systems KV1, KH1, KV2, KH2 are oriented in such a way that their particular measuring and image recording directions (viewing directions) are oriented essentially parallel to longitudinal sides 5, 7 of measuring plane 4 or of the vehicle to be measured. Each of measuring devices KV1, KH1, KV2, KH2 of each of the two measuring sensors MW1, MW2 is oriented in the direction of front side 6 or back side 8 of measuring plane 4, so that each of recording devices KV1, KH1, KV2, KH2 optically detects one of measuring panels VL, HL, VR, HR, and each of measuring panels VL, HL, VR, HR is optically detectable by one of recording devices KV1, KH1, KV2, KH2.

Each of the two measuring sensors MW1, MW2 has been independently calibrated prior to the actual measurement, using a known method, so that the local coordinate systems of both image recording devices KV1, KH1, KV2, KH2 of one measuring sensor MW1, MW2 are oriented parallel to each other, or the deviations from the parallelism are known and may be taken into account when evaluating the measurements. Measurement errors resulting from the deviation of the recording directions of image recording devices KV1, KH1, KV2, KH2 within a measuring sensor MW1, MW2 from the parallelism are corrected in this way.

The coordinate systems of the two measuring sensors MW1, MW2 are identified by X₁ and X₂ in FIGS. 1 and 2.

Measuring panels VL1, HL1, VR1, HR1, which are represented by dashed lines in FIG. 1, symbolize the positions in which measuring panels VL, HL, VR, HR appear from the perspective of particular measuring sensors MW1, MW2; n_{VL1}, n_{VR1}, n_{HL1}, n_{HR1}, n_{VL2}, n_{VR2}, n_{HL2}, n_{HR2} designate the associated normal vectors, i.e., vectors which are situated at a right angle to the plane of particular measuring panels VL1, HL1, VR1, HR1.

In particular, measuring panels VL1, HL1 symbolize the positions of left measuring panels VL and HL, which have been determined by left measuring sensor MW1. Likewise, measuring panels VR1 and HR1 symbolize the positions of right measuring panels VR and HR, which have been determined by right measuring sensor MW2.

Once the positions of measuring panels VL, HL, VR, HR have been recorded in a first measuring step in the configuration shown in FIG. 1, in which first measuring sensor MW1 is situated on the left of measuring plane 4 and second measuring sensor MW2 is situated on the right thereof, and once the positions of measuring panels VL, HL, VR, HR have been determined from the perspective of particular measuring sensor MW1, MW2, the two measuring sensors MW1, MW2 are interchanged. This means that first measuring sensor MW1, which is situated on the left of measuring plane 4 in FIG. 1 is situated on the right side of measuring plane 4, and second measuring sensor MW2, which is situated on the right of measuring plane 4 in FIG. 1 is situated on the left of measuring plane 4, as shown in FIG. 2.

During the interchange, measuring sensors MW1, MW2 are also rotated around their particular vertical axes, which are oriented perpendicularly to the plane of the drawing in FIGS. 1 and 2, so that image recording devices KH2, KV2, KH1 and KV1, which face front side 6 and back side 8 of measuring plane 4, are also interchanged with each other. This means that those image recording devices KV1, KV2 which detect front measuring panels VL and VR in the configuration shown in FIG. 1 record images of back measuring panels HL and HR in the configuration shown in FIG. 2, and those image recording devices KH1, KH2 which detect back measuring panels HL and HR in the configuration shown in FIG. 1 record images of front measuring panels VL and VR in the configuration shown in FIG. 2.

In the configuration of measuring sensors MW1, MW2 shown in FIG. 2, images of measuring panels VL, HL, VR, HR are also recorded in a second measuring step and the positions of measuring panels VL, HL, VR, HR are determined from the perspective of particular measuring sensor MW1, MW2.

Measuring panels VL2, HL2, VR2, HR2 represented by dashed lines in FIG. 2 symbolize the position in which measuring panels VL, HL, VR, HR appear from the perspective of particular measuring sensors MW1, MW2.

The coordinates of measuring panels VL, HL, VR, HR, which have been determined in the two measuring steps, are transformed onto each other in a subsequent step. When the measuring system formed by the two measuring sensors MW1, MW2 is calibrated, the coordinates of measuring panels VL, HL, VR, HR, which have been determined in the two measuring steps carried out, are identical in a global coordinate system, and the images of measuring panels VL, HL, VR, HR are mapped identically onto each other.

However, the two measuring sensors MW1 and MW2 are generally not calibrated to each other from the start, so that the coordinates of measuring panels VL, HL, VR, HR determined in the two measuring steps carried out are not identical in the global coordinate system.

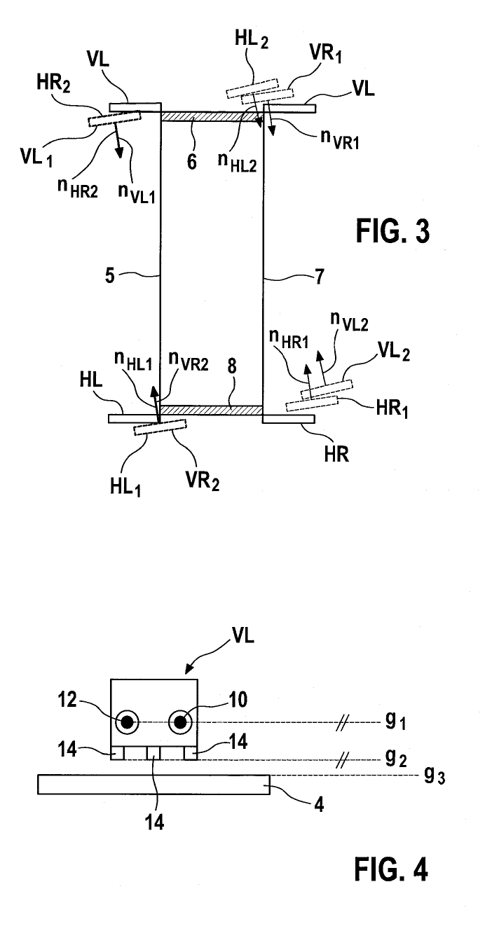

FIG. 3 shows the result of a transformation of this type by way of example.

Mappings VL1 and HR2 of measuring panel VL have been selected as a reference for the transformation and mapped onto each other. Since decalibrated camera systems KV1, KH1, KV2, KH2 are made visible only on one side, mappings HL1 and VR2 of measuring panel HL are also identically mapped onto each other.

Mappings VR1 and HL2 as well as HR1 and VL2 are not congruent but deviate from each other if the recording directions of camera systems KV1, KH1, KV2, KH2 are not oriented exactly parallel to each other but instead are decalibrated.

If both measuring sensors MW1, MW2 have an equivalent decalibration, the errors cancel each other out, and it is not necessary to calculate a correction value for the calibration.

If the deviation exceeds a predefined limiting value, at least one correction value RSL, RSR is calculated to correct the measuring results. The accuracy of the calibration, and thus also the maximum possible accuracy of the subsequent measurements, is determined by the selection of the limiting value.

Correction values RSL, RSR are derived from deviations W1=VR1−HL2 and W2=HR1−VL2 of the positions of measuring panels VL, HL, VR, HR between the two configurations of measuring sensors MW1, MW2 shown in FIGS. 1 and 2:

W1=VR1−HL2=2RSL−2RSR

W2=HR1−VL2=2RSL−2RSR.

The linear system of equations includes two equations having two unknowns; it is therefore not uniquely solvable. The individual errors in the two measuring sensors MW1 and MW2 may therefore not be calculated using this method.

For measuring the axles, for example, it is sufficient for the track directions on the left and right sides of the vehicle to match each other relatively, i.e., for the left and right track directions to be parallel to each other.

The linear system of equations is therefore solved under assumption RSR=0, i.e., the calibration is reduced to the correction of camera systems KV1, KH1 of left measuring sensor MW1. Alternatively, camera systems KV2, KH2 of right measuring sensor MW2 may be calibrated under assumption RSL=0.

The following results from the linear system of equations under described assumption RSR=0:

RSL=(W1+W2)/4.

By taking into account correction value RSL determined in this way when evaluating the measurements, deviations in the measuring directions of the two measuring sensors MW1, MW2 from the parallelism may be equalized, and the track of the vehicle may be measured with a high degree of accuracy.

Since decalibrated camera systems KV1, KH1, KV2, KH2 are made visible only on one side, the coordinates of measuring panels VL1 and HL1 may be transformed together onto the coordinates of measuring panels HR2 and VR2 to minimize noise and/or other residual errors and to further increase the accuracy.

It is possible to further increase the accuracy by additionally carrying out the transformation for the measuring panels on the other side (transformation from VR1 and HR1 to HL2 and VL2) and calculating the corresponding deviations on the left side of measuring station 2. The correction value ascertained in this way is averaged by the correction value previously ascertained using the measuring panels on the first side.

Correction values RSL and RSR determined in the method described above are stored and taken into account in each subsequent measurement. Due to the calibration, the two measuring sensors MW1, MW2 form a measuring system and may be operated only together. If one of the two measuring sensors MW1, MW2 is exchanged, a recalibration must be carried out to determine new correction values RSL and RSR for the newly formed measuring system.

FIG. 4 shows a measuring panel VL by way of example for use on a measuring plane 4, which is made available, for example, by a car lift.

Measuring panel VL has at least two measuring points 10, 12 and three feet 14 (three-point mounting).

The spatial orientation of straight lines g₂ (zero direction) defined by feet 14 in relation to straight line g₁ defined by the at least two marks 10, 12 on measuring panel VL is known. For the sake of simplicity, these two straight lines g₁, g₂ are drawn parallel to each other in FIG. 4. However, a parallelism of this type is not absolutely necessary; instead, it is sufficient if the angle between the two straight lines g₁, g₂ is known.

The measurement of marks 10, 12 on panel VL is carried out after panel VL has been supported by feet 14 on measuring plane 4, which defines a straight line g₃.

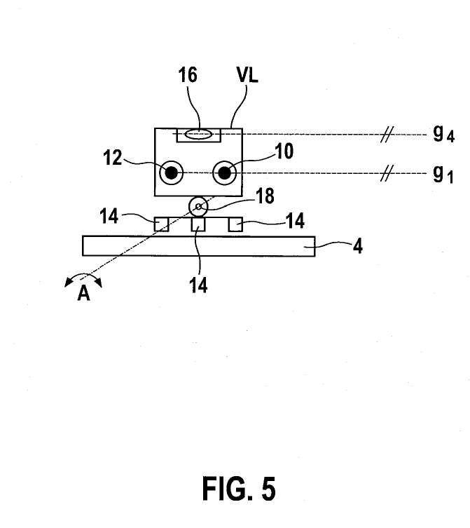

FIG. 5 shows an alternative exemplary embodiment in which the measurement may be carried out on any measuring station (e.g., a factory floor), no requirements being imposed on the levelness and orientation of measuring plane 4.

In the exemplary embodiment shown in FIG. 5, measuring panel VL has a level (spirit level) which is situated in a defined orientation g₄ in relation to straight line g₁, which is defined by at least two measuring points 10, 12 situated on measuring panel VL. In FIG. 5, straight lines g₁ and g₄ are illustrated parallel to each other. However, this is not absolutely necessary; instead, it is sufficient if the orientation of level 16 in relation to straight line g₁ defined by measuring points 10, 12 is known.

Measuring panel VL is connected to feet 14 via an articulation 18 in such a way that measuring panel VL, together with level 16 and measuring points 10, 12, is pivotable around an axis A of articulation 18.

Before the measurements are carried out, measuring panel VL is pivoted around rotation axis A of articulation 18, after it has been placed on measuring plane 4, and locked in a desired position, which may be read from level 16. Marks 10, 12 on measuring panel VL are detected by one of image recording devices KH1, KV1, KH2, KV2 of measuring sensors MW1, MW2 after the described orientation of measuring panel VL has been carried out.

Since the spatial orientation of measuring panel VL is defined with the aid of level 16, and the orientation of level 16 in relation to measuring points 10, 12 is known, the calibration and measurement may be carried out with the aid of a measuring panel VL of this type independently of the spatial orientation and levelness of measuring plane 4. The measurement method may be carried out flexibly at any location with a high degree of accuracy.

An absolute camber correction may be derived from the deviation in direction g₁ defined by marks 10, 12 from zero direction g₂ or g₄. The camber correction is a correction of the error resulting from the combination of an image recording system KH1, KV1, KH2, KV2 and associated reference system R1, R2.

If more than one camera is used and the assignment between the cameras is known, two marks 10, 12 on each of measuring panels VL, VR, HL, HR are sufficient if the two marks 10, 12 are situated on an exactly horizontal line.

If the assignment between the cameras is not known, or if only one (mono) camera is used, at least three marks 10, 12 are needed on each of measuring panels VL, HL, VR, HR. At least three marks 10, 12 on each of measuring panels VL, HL, VR, HR are also needed for determining the track.

1-10. (canceled)

11. A method for calibrating a measuring system for measuring a vehicle, including a measuring plane which is designed to accommodate the vehicle to be measured, and two measuring sensors, each of the measuring sensors having at least two camera systems and one reference system, the method comprising:
positioning at least four measuring panels on the measuring plane;
orienting the measuring sensors such that at least one of the measuring panels is in a field of vision of each camera system, and each of the measuring panels is in the field of vision of at least one of the camera systems;
carrying out a first measuring step, which includes recording images of the measuring panels with aid of the camera systems;
interchanging the two measuring sensors;
carrying out a second measuring step, which includes recording images of the measuring panels with aid of the camera systems;
determining spatial positions of the measuring panels from the images recorded in the first and second measuring steps; and
calculating at least one correction value from a difference between the spatial positions of the measuring panels which have been determined from the images recorded in the first and second measuring steps.

12. The method according to claim 11, wherein the determination of the correction value includes solving a linear system of equations.

13. The method according to claim 12, wherein the correction value for a first measuring sensor is set to a predefined value for calculating the correction value for a second measuring sensor.

14. The method according to claim 11, further comprising:
comparing normal vectors of at least two measuring panels with each other.

15. The method according to claim 14, wherein the correction values for two pairs of measuring panels are determined, and a final correction value is determined by averaging the two correction values.

16. The method according to claim 11, wherein the measurement is carried out on a leveled platform, the platform and the measuring panels being oriented in relation to earth's gravitational field.

17. The method according to claim 11, wherein at least one of the measuring panels has at least two measuring points whose orientation in relation to a spatial orientation of at least one foot of the measuring panel is known.

18. The method according to claim 11, wherein at least one of the measuring panels is rotatably mounted.

19. The method according to claim 11, wherein at least one measuring panel has at least one level which is suitable for determining a spatial orientation of the measuring panel.

20. The method according to claim 11, wherein serial numbers of the measuring sensors are additionally ascertained and stored together with the correction values.
